(19) United States
(12) Patent Application Publication
(10) Pub. No.: US 2005/0212822 A1
(43) Pub. Date: Sep. 29, 2005

(54) Display device, display method and advertisement method using display device

(76) Inventors: Yoshinori Honma, Yoshida-machi (JP); Nobuyuki Hayashi, Yoshida-machi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/516,551

(22) PCT Filed: Jun. 3, 2003
(86) PCT No.: PCT/JP03/06986

§ 371 Date: Jun. 6, 2005

(30) Foreign Application Priority Data
Jun. 3, 2002 (JP) 2002-161726
Jul. 24, 2002 (JP) 2002-215751

(51) Int. Cl. G09G 5/00

(52) U.S. Cl. 345/649

(57) ABSTRACT

The present invention provides a display apparatus and a display method and an advertisement method using the display apparatus which may realize an innovative image that has never been realized by a hardware structure that is extremely easy and costless and in which an excellent advertisement effect is expected as, for example, a poster advertisement. It is composed of a sequential scanning circuit for signal converting a jump scanning type image signal into a sequential scanning type and a signal turning unit for turning the signal through 90 degrees to make it possible to feed the image signal turned through 90 degrees in real time.

### BACKGROUND OF THE INVENTION

1. Field of the Invention

The present invention relates to a display apparatus in which a laterally elongated display is changed in orientation in a vertical direction to be used as a vertical display and an image is displayed on this vertical display in real time from an image feeding unit.

2. Background Art

A technical innovation of an image feeding unit such as a TV receiver, a VTR, a camera and the like is remarkable and in this connection, a technical innovation of a display is also remarkable to attain a day-by-day development.

In particular, recently, a plasma display has been developed and put into practice so that a clear image may be displayed on a thin large-size display. Although it is still expensive, the image display technology has been drastically developed.

It is possible to clearly display a large-field realistic image without taking a large space by hooking such a plasma display for example on a wall or embedding it in a wall. However, this has not yet attained a satisfactory effect as an effective advertising means.

Namely, such a trial that a letter is superimposed on an image field by synthesizing with letter broadcasting or letter data or a letter telop is displayed in a marginal portion of the image field so that an advertising sentence may be displayed while a motion commercial film is displayed clearly has been already attained. However, it is hard to obtain the satisfactory advertising effect.

Even if a large-size plasma display is set not only at home but also in a place where people gather together, for example, shops, air ports, streets or the like and a clear advertising image is displayed there, although a temporary attention may be attracted to a beautiful large-size image field of this image, it is impossible to attract the attention to the contents of the advertisement.

In view of such a situation, as a result of repeated review and studies, the applicant has found that its cause is largely due to the fact that the image is displayed on the laterally elongated display.

Namely, in the image display technology thus far proposed, a laterally elongated image such as cinema is regarded to be similar to a human view field, a clear image such as a photographic picture is realized as much as possible and efforts are made to a display method of a wide laterally elongated image field. As a result, almost all the up-to-date displays are of a laterally elongated display type.

Accordingly, it is safe to say that almost all plasma displays that is expensive but large in size and thin to make it possible to provide a realistic clear image are also of a laterally elongated display type.

However, even if such laterally elongated displays are used for advertisement, although they are beautiful, it is impossible to ensure the satisfactory advertising effect.

Namely, if the advertising image is displayed on a laterally elongated display, so far as it is not concerned with a very interesting advertisement away from the thus far established common concept (potential sense) to a person who watches the image, such recognition is only caused that it is simple television broadcasting or a VTR runs without any attention. Even if a special commercial image is displayed, such recognition that a simple television commercial film runs is formed and the advertisement effect exceeding the television broadcasting (television commercial film) will not be generated.

Therefore, the applicant who has found out a problem that even if the plasma display that is the highest in the up-to-date image display technology is used, it is impossible to expect the advertising effect for this reason conceived that the laterally elongated display was intentionally changed in orientation and the advertisement was displayed in the vertical display changed in orientation.

It was found that the method to display the advertisement on this vertical display was more effective than expected and it was the actual state that the applicant himself was surprised at its effect.

Namely, a so-called poster advertisement effect was exhibited and it was newly recognized how large the advertisement capability of the poster advertisement was.

Almost all the current advertisement poster is of a vertical type. For this potential recognition, the vertical advertisement image may catch eyes and may be recognized as advertisement and attractive.

Accordingly, if the advertisement is displayed in a vertical manner, even if it is a motion picture, the advertisement may catch eyes and the advertisement is attractive to such an extent that the advertisement remains in brains as the advertisement poster on which the advertisement image is displayed while it was not recognized as simple television broadcasting or television commercial. Due to the appeal of the beautifulness of the image and the motion picture, the advertising information is propagated instantaneously.

If the poster advertisement is performed with a thin plasma display, the advertisement effect is more excellent due to the mobility and the clear beautifulness because of its thinness.

However, an advertisement means is being already practiced in which, while an attention is paid to this poster advertisement effect, a compiled advertisement image produced by a personal computer on a vertical display which is the laterally elongated display put in a vertical manner, or otherwise, in order to synthesize and display a motion picture, an image signal of a DVD or a VTR is once stored in the personal computer, the image is turned through 90 degrees by a software of the personal computer, and even if the image is displayed on the vertical display which is the laterally elongated display turned in a vertical manner, by this 90 degree turning process, the image may be displayed in a correct direction in the same manner as the manner that the image is displayed in the laterally elongated display.

However, according to this method in which the image is once stored in the personal computer and is turned through 90 degree, it is impossible to display various images on the longitudinal display in real time or to select, switch and display the images as desired.

Namely, according to the method in which the turning process is performed by using a 90 degree turning software in the personal computer and this is compiled and displayed on the vertical display, as a result, it is possible to display the motion picture on the vertical display which is the laterally elongated display like a poster advertisement but it is always necessary to perform the storage process in advance, which is troublesome. (In addition, not only does it need the time or steps but also the clearness of the image is remarkably deteriorated due to the process through the personal computer.)

Accordingly, conventionally, in order to use the vertical display while changing the orientation of the lateral elongated display and to display the image on the vertical display, it is necessary to perform the process in advance by the software. It is therefore impossible to perform the poster advertisement with the image in real time.

In other words, since the image is not displayed in real time, in order to switch this image to another image, for example, in the case the image of a DVD player or a VTR player is to be replayed and displayed, it is impossible to change the image to another image or video tape, to switch the program to TV broadcasting, to change broadcasting channels or to switch the image to a current camera image of a place where a camera is set only by exchanging pieces of DVD software. It is thus impossible to perform such switching operation at site as desired or to continuously display the image in real time.

On the other hand, basically, it is sufficient to prepare and obtain a number of vertical image sources. However, there are not many such image sources. Also, it is possible to produce the image while keeping the pickup camera is set in a vertical manner. However, this is also costly and hard to attain.

In contrast, almost all broadcasting image or conventional software for DVDs or VTRs is also of a laterally elongated display type.

In view of the foregoing difficulties, according to the present invention, it is possible to readily realize an advertising medium that exhibits an advertising effect that could not be attained at all by a laterally elongated image field (laterally elongated display), i.e., a remarkable eye catching effect caused by a poster advertising effect with a vertical display, in which an already present laterally elongated display, for example, a thin large-size laterally elongated plasma display which clearly displays image is set up while changing the orientation in a vertical manner to thereby readily realize the vertical display with ease, an image signal from an image feeding unit is subjected to a 90 degree turning process and outputted to the vertical display, and this is displayed in real time on the above-described vertical display. It is possible to realize an innovative image that could not be realized thus far with a less expensive, extremely easy hardware structure without needs to process through the software using a personal computer or the like. Thus, for example, it is possible to provide an extremely innovative, practical display apparatus in which the excellent advertising effect may be expected as a poster advertisement.

### SUMMARY OF THE INVENTION

The essence of the present invention will now be described with reference to the accompanying drawings.

According to a first aspect of the present invention, there is provided a display apparatus characterized by comprising an input section 2 for inputting an image signal outputted in real time from an image feeding unit 1 such as a TV receiver, a VTR, a DVD, a camera or the like, a 90 degree image turning processing section 4 for writing in a memory the image signal to be inputted in real time from the input section 2 and making it possible for turning the written image data through 90 degrees and for feeding and displaying the data to the vertical display in real time, and an output section 5 for outputting a sequential scanning type image signal turned through 90 degrees in real time, wherein the image of the image feeding unit 1 turned through 90 degrees may be fed and displayed in real time on the vertical display 6 which is set in the vertical direction by turning a laterally elongated display through 90 degrees, the turning image data already subjected to the 90 degree turning process by said 90 degree image turning processing section 4 are always once written in an image memory, the image memory is renewed in real time, and the turning image data read out from the image memory is outputted to said vertical display 6 so that the data may be fed and displayed in real time on the vertical display 6, further comprising an image data output section 10 in which the turning image data written in each area which is obtained by dividing area of said image memory into a plurality of area may be displayed in a corresponding display area of said vertical display 6 divided in a plurality of area in the same manner, and a renewal area switching section 11 structured to make it possible to change each area of said image memory from a mode of renewing the turning image data in real time to a mode of stopping the renewal of the turning image data or from the mode of stopping the renew of the turning image data to the mode of renewing the data in real time, wherein the image signal for advertisement turned through 90 degrees and outputted from said output section 5 is inputted to said vertical display 6 and the image of said image feeding unit 1 may be displayed on said vertical display 6 in real time and said renewal area switching section 11 is set so as to switch a mode of whether or not the renewal of the turning image data is automatically performed in the divided area of the image memory in accordance with a signal contained in the image signal or a situation of a picture image or a still image of the image signal outputted from the image feeding unit 1.

In the display apparatus according to the first aspect of the invention, turning image data to be renewed in real time in response to the image signal to be inputted in real time from the image feeding unit 1 are displayed as a normal image that may represent a motion picture to the image display area of said vertical display 6 corresponding to one area that is set to renew in real time the turning image data of said image memory, and the turning image data, renewed last, of the turning image data renewed in real time are displayed as a fixed image to said vertical display 6 corresponding to other predetermined area that is set to stop the renewal of said turning image data whereby the fixed image and the normal image of the image signal from the image feeding unit 1 may be displayed to said vertical display 6.

In the display apparatus according to the first aspect, the overall image displayable range of the large size vertical display 6 may be essentially occupied by a plurality of divided image display areas.

In the display apparatus according to the third aspect, the overall image displayable range of the vertical display 6 is divided into image display area juxtaposed in a vertical direction.

According to a fifth aspect of the invention, there is provided a display apparatus characterized by comprising an input section 2 for inputting an image signal outputted in real time from an image feeding unit 1 such as a TV receiver, a VTR, a DVD, a camera or the like, a scanning type converting section 3 for converting into a sequential scanning type image signal a jump scanning type image signal inputted in real time from the input section 2 or an image signal whose image has been turned through 90 degrees (including 270 degrees), a 90 degree image turning processing section 4 for writing in a memory the image signal to be inputted in real time from the input section 2 or the image signal converted into the sequential scanning type and for turning the written image data through 90 degrees and for feeding and displaying the data to the vertical display 6, and an output section 5 for outputting the sequential scanning type image signal turned through 90 degrees in real time, wherein the image of the image feeding unit 1 turned through 90 degrees may be fed and displayed in real time on the vertical display 6 which is set in the vertical direction by turning a laterally elongated display through 90 degrees, the turning image data already subjected to the 90 degree turning process by said 90 degree image turning processing section 4 are always once written in an image memory, the image memory is renewed in real time, and the turning image data read out from the image memory is outputted to said vertical display 6 so that the data may be fed and displayed in real time on the vertical display 6, further comprising an image data output section 10 in which the turning image data written in each area which is obtained by dividing area of said image memory into a plurality of area may be displayed in a corresponding display area of said vertical display 6 divided in a plurality of area in the same manner, and a renewal area switching section 11 structured to make it possible to change each area of said image memory from a mode of renewing the turning image data in real time to a mode of stopping the renewal of the turning image data or from the mode of stopping the renewal of the turning image data to the mode of renewing the data in real time, wherein the image signal for advertisement turned through 90 degrees and outputted from said output section 5 is inputted to said vertical display 6 and the image of said image feeding unit 1 may be displayed on said vertical display 6 in real time and said renewal area switching section is set so as to switch a mode of whether or not the renewal of the turning image data is automatically performed in the divided area of the image memory in accordance with a signal contained in the image signal or a situation of a picture image or a still image of the image signal outputted from the image feeding unit 1.

In the display apparatus according to the fifth aspect, turning image data to be renewed in real time in response to the image signal to be inputted in real time from the image feeding unit 1 are displayed as a normal image that may represent a motion picture to the image display area of said vertical display 6 corresponding to one area that is set to renew in real time the turning image data of said image memory, and the turning image data, renewed last, of the turning image data renewed in real time are displayed as a fixed image to said vertical display 6 corresponding to other predetermined area that is set to stop the renewal of said turning image data whereby the fixed image and the normal image of the image signal from the image feeding unit 1 may be displayed to said vertical display 6.

In the display apparatus according to the fifth aspect, the overall image displayable range of the large size vertical display 6 may be essentially occupied by a plurality of divided image display areas.

In the display apparatus according to the seventh aspect, the overall image displayable range of the vertical display 6 is divided into image display area juxtaposed in a vertical direction.

With the structure according to the invention, it is possible to readily realize an advertising medium that exhibits an advertising effect that could not be attained at all by a laterally elongated image field (laterally elongated display), i.e., a remarkable eye catching effect caused by a poster advertising effect with a vertical display, in which an already present laterally elongated display, for example, a thin large-size laterally elongated plasma display which clearly displays image is set up while changing the orientation in a vertical manner to thereby readily realize the vertical display with ease, an image signal from an image feeding unit is subjected to a 90 degree turning process and outputted to the vertical display, and this 90 degree turning processed image data are displayed in real time on the above-described vertical display. It is possible to realize an innovative image that could not be realized thus far with a less expensive, extremely easy hardware structure without needs to process through the software using a personal computer or the like. Thus, for example, it is possible to provide an extremely innovative, practical display apparatus, a display method and an advertising method using the display apparatus and the display method, in which the excellent advertising effect may be expected as a poster advertisement.

### BRIEF DESCRIPTION OF THE DRAWINGS

FIG. 1 is an illustrative perspective view showing the use condition of an embodiment.

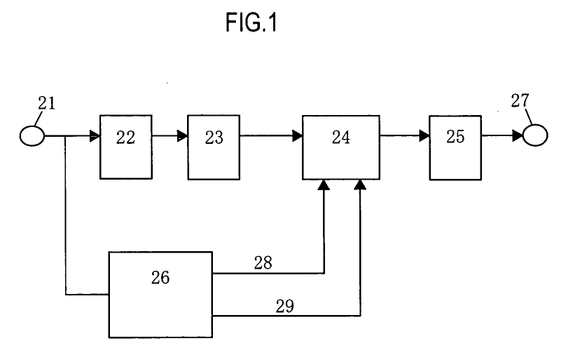

FIG. 2 is a schematic illustrative block diagram of the embodiment.

FIG. 3 is a schematic illustrative block diagram of the embodiment.

FIG. 4 is an illustrative frontal view showing an image display area of the vertical display of the embodiment.

FIG. 5 is an illustrative frontal view of contents inputted into a display apparatus according to the embodiment.

FIG. 6 is an illustrative frontal view of a display showing the use condition of the embodiment.

FIG. 7 is an illustrative frontal view of contents inputted into the display apparatus according to the embodiment.

FIG. 8 is an illustrative frontal view of the display showing the use condition of the embodiment.

FIG. 9 is an illustrative frontal view of contents inputted into the display apparatus according to the embodiment.

FIG. 10 is an illustrative frontal view of the display showing the use condition of the embodiment.

### DESCRIPTION OF PREFERRED EMBODIMENTS

A mode for embodying the present invention which may be considered as a best mode (how to embody the invention) will now be described in brief while showing its effective result with reference to the drawings.

An image to be inputted to the display apparatus according to the present invention is turned through 90 degrees and is outputted and displayed on a laterally elongated display or a vertical display 6 installed longitudinally by turning the laterally elongated display by 90 degrees to be set in a vertical direction.

Namely, an image signal outputted from an image feeding unit 1 is turned in real time through 90 degrees (270 degrees) by the display unit, fed in real time to the above-described laterally elongated or vertical display 6 and displayed thereon.

Accordingly, for example, the conventional lateral elongated display is simply set in a vertical direction so that the vertical display 6 may be provided. The real time image signal of jump scanning type simply outputted from the image feeding unit 1 without once storing and compiling the image source into software of a personal computer or the like into the vertical display 6 whose orientation has been thus changed is converted into, for example, the sequential scanning type by a hardware structure and turned through 90 degrees, outputted and fed to the vertical display 6 in real time to thereby make it possible to display in a correct image orientation.

Accordingly, for example, the thin plasma display is used and this is set in a vertical manner whereby it is possible to realize the poster advertisement in which various images may be simply switched over as desired at site. It is therefore possible to obtain the extremely excellent advertising effect that could not be attained at all by the laterally display by this poster advertisement.

Also, the turning image data already subjected to the 90 degree turning process by a 90 degree image turning processing section 4 are always once written in an image memory, and the turning image data read out from this image memory are outputted to the above-described vertical display 6 while this image memory is renewed in real time so that the image data may be fed and displayed in real time on the vertical display 6. At the same time, there are provided an image data output section 10 that is structured so that it divides an area of the above-described image memory into a plurality of areas and may display the turning image data, written in each divided area, on a corresponding image display area, divided into a plurality of areas in the same manner, of the above-described vertical display 6 and a renewal area switching section 11 that is structured so that it may renew each area of the above-described image memory from a mode of renewing the turning image data in real time to a mode of stopping the renewal or from the mode of stopping the renewal of the turning image data to the mode of renewing in real time. The 90 degree turning image signal outputted from the above-described output section 5 is inputted into the above-described vertical display 6 and may be displayed on the above-described vertical display 6 in real time. The above-described renewal area switching section is set for switching whether or not the renewal of the turning image data in the divided area of the image memory is performed automatically, in accordance with the situation of the still image or the motion image of the image signal outputted from the image feeding unit or the signal included in this image signal. For example, the area of the above-described image memory corresponding to a blank space generated in a lower portion or an upper portion of the above-described motion image for advertisement is renewed into the mode of renewing the turning image data in real time and at the same time, the area which has displayed the image signal fed and displayed in real time is renewed into the mode of stopping the renewal of the area whereby the above-described image signal inputted in real time is fed and displayed in a portion which has been the above-described blank space. One site, which has been renewed last, of the above-described image signal inputted in real time may be displayed as a stationary image in a portion where the image has been displayed.

Namely, it is unnecessary to separately input the image produced by using a personal computer or the like. It is therefore unnecessary to modify this image or to connect and operate the personal computer. Since the blank space may be filled with image extremely easily by using a single image source by one switching operation of the above-described renewal area switching section 11, the system is extremely easy to handle and is less expensive.

Also, for example, the image from the image feeding unit 1 for essentially occupying the entire image displayable area of the vertical display 6 is adapted to be able to be displayed on the vertical display. It is possible to display the above-described motion image for advertisement without any blank space in the image field of the above-described vertical display 6 only by inputting the image signal for the above-described vertical display without any needs to display the image, worked by a personal computer or the like as in the conventional manner, on the blank space.

Namely, since it is unnecessary to separately input the image produced by thus using the personal computer or the like, it is unnecessary to work this image or to connect and operate the personal computer and it is possible to fill the above-described blank space with the image extremely easily by one image source, which is extremely easy to handle and costless.

Furthermore, for example, the turning image data are displayed as a regular image (motion image) that may display the turning image data renewed in real time in correspondence with the image signal inputted in real time from the image feeding unit 1 on one hand, without simply displaying the same image on one image display area of the image display area of the vertical display 6 and the other predetermined image display area and the turning image data renewed last in the turning image data renewed in real time are displayed as a stationary image (still image) on the other hand. In the image where the motion image for propaganda of introducing a commercial product and a still image where a letter telop such as a company name, a product name and the like used in a general TV commercial film are displayed in order, it is possible to store (freeze) in the blank space the letter telop which should run inherently due to the start of the motion picture. It is possible to constitute the innovative advertisement image which may be displayed on the vertical display together with the motion image.

Consequently, according to the present invention, for example, the laterally elongated plasma display which is large in size and thin and displays an image clearly is set up with its orientation being changed in the vertical direction so that the vertical display may readily be realized. The image signal from the image feeding unit is subjected to the 90 degree turning process in real time and outputted to the vertical display in an easy and stable method, and the image data subjected to the 90 degree process are displayed on the above-described vertical display. Accordingly, it is possible to readily realize the advertisement medium which exhibits the advertisement effect that has not been realized by the laterally elongated image field (laterally elongated display) at all, i.e., the excellent catch eye effect due to the poster advertisement effect because of the vertical display. Accordingly, in synergy with the eye catching effect exhibited by the vertical display, it is possible to realize an innovative image that could not be realized thus far with a less expensive, extremely easy hardware structure without needs to process through the software using a personal computer or the like. Thus, for example, it is possible to provide an extremely innovative, practical display apparatus in which the excellent advertising effect may be expected as a poster advertisement.

An embodiment of the present invention will now be described with reference to the drawings.

In the display apparatus according to the embodiment, an image signal outputted from the image feeding unit 1 such as TV broadcasting, a VTR, a camera, a personal computer or the like is turned through 90 degrees (270 degrees) and inputted into the elongated display 6 which is changed in the orientation of the laterally elongated display by turning the laterally elongated display through 90 degrees.

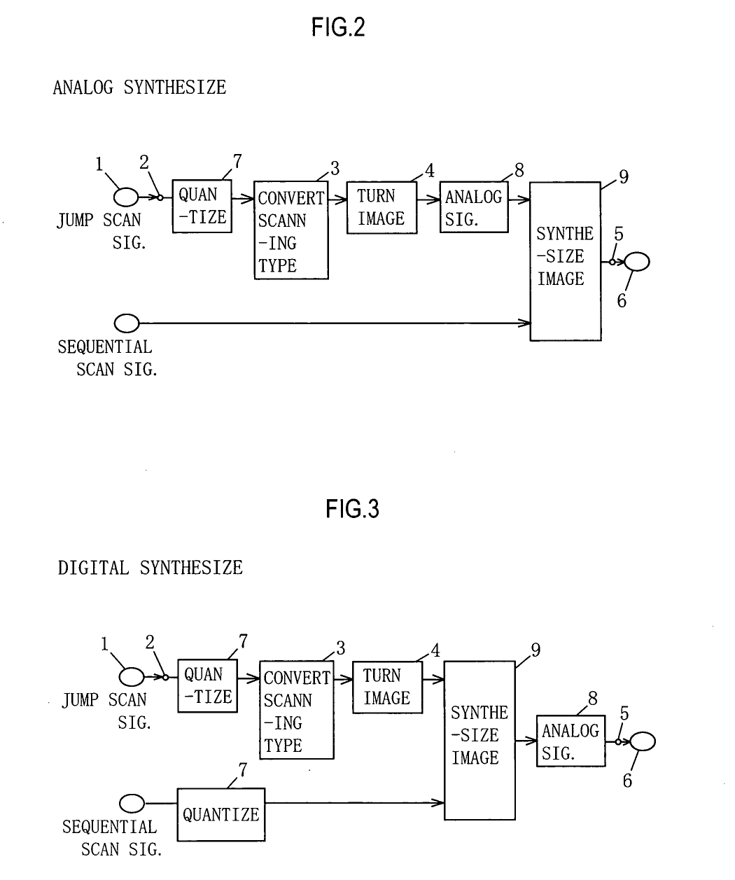

Namely, the display apparatus according to the embodiment is composed, as shown in FIG. 2, of an image data outputting section 10 in which a jump scanning type image signal of TV broadcasting, a VTR, a camera, a personal computer or the like is converted into a sequential scanning type, and the image signal that has been converted into the sequential scanning type is turned through 90 degrees (270 degrees) (possible to convert the 90 degree turn image into the sequential scanning type after the turn), the turning image data read out from the image memory are outputted to the vertical display 6 while always once writing to the image memory the turning image data subjected to the 90 degree turning process and renewing in real time the image memory to make it possible to feed and display the image data in real time to the vertical display 6, and the turning image data where a area of the above-described image memory is divided into a plurality of areas and which is written in each divided area may be displayed in a corresponding image display area of the above-described vertical display 6 divided in a plurality of areas in the same manner, and a renewal area switching section 11 in which each of the above-described areas may be changed from a mode of renewing the turning image data in real time to a mode of stopping the renewal in real time or the mode of stopping the renewal to the mode of renewing the turning image data in real time to thereby make it possible to display the image on the above-described blank space without needs of the personal computer.

This image data output section 10 is structured to as to feed and display the turning image data written in real time in the above-described image memory on the above-described vertical display 6 in real time not for each area but together.

Namely, the above-described image data outputting section 10 is structured so that the turning image data to be renewed every time in response to the image signal to be inputted in real time from the image feeding unit 1 are displayed as a regular image (motion picture) which may be displayed as a picture image to the image display area of the above-described vertical display 6 corresponding to one area set to renew in real time the turning image data to be written in the above-described image memory, and the turning image data renewed last in the turning image data renewed in real time are displayed as a stationary image (still picture) to the image display area of the above-described display 6 corresponding to another predetermined area set to stop the renewal of the above described turning image data. Accordingly, the motion pictures or the stationary pictures are displayable in the image display area divided into a plurality of areas, respectively.

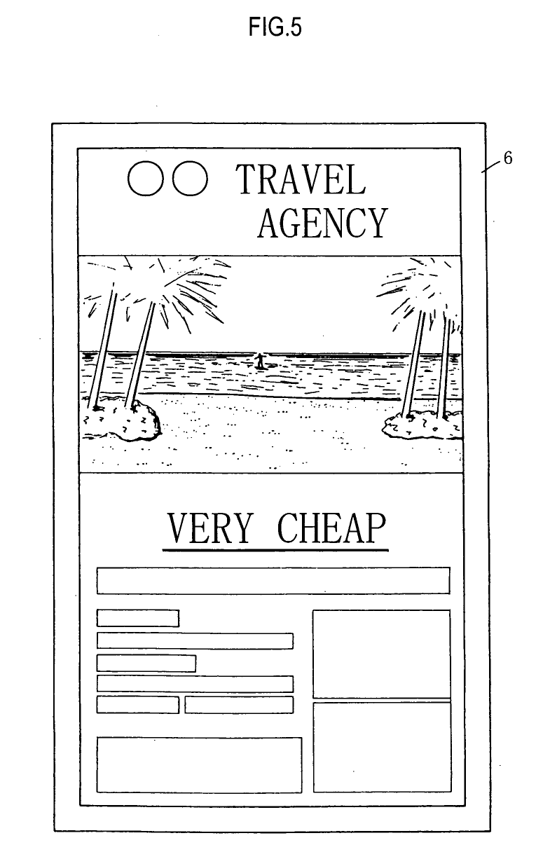

Also, the area of the image memory is divided into two so that the overall image displayable range of the above-described vertical display 6 may display the image divided into the two image display areas having substantially the same area juxtaposed in the up-and-down direction. At the same time, the overall image displayable region may essentially occupy the two-divided image display region (see FIG. 4). Namely, the image to be displayed on this vertical display 6 is composed, in scheme, of the two images arranged in the vertical direction and displayed in the regular laterally elongated display. It is possible not only to display the images displayed in the laterally elongated display as they are without any abnormal feel but also to utilize the image displayable range of the above-described vertical display 6 without any dead space to thereby make it possible to further effectively utilize the large size display.

Incidentally, in the embodiment, the two image areas of the above-described display 6 are juxtaposed in the vertical direction. Three or four image display area or more may be juxtaposed together. In this case, it is possible to display a plurality of still pictures together with the motion picture on the above-described vertical display 6. Also, a plurality of pictures may be arranged in the right and left directions.

Also, the renewal area switching section 11 is set up so that the turning image data are written and renewed in real time in one area selected by the renewal area switching section 11 (possible to stop the renewal) and the renewal is stopped in another area.

Accordingly in the embodiment, the motion picture and the still picture are displayed in the image display region of the vertical display 6 by a single image source to be inputted (for example, real time NTSC image signal) to make it possible to display the advertisement image without any blank space.

Also, in the embodiment, the above-described renewal area switching section 11 is set up so as to change a mode of whether or not the turning image data in one area of the image memory and the other area are automatically renewed. Accordingly, the position where the motion picture (still picture) is displayed is switched suitably in correspondence with the image to be displayed. An impression that has not been experienced is given to the observer so as to attract the attention so that the extremely innovative advertisement image may be provided.

More specifically, as shown in FIG. 2, the past image data are compared with the current image data in, for example, one area (area A) where a mode of renewing the turning image data in real time is set. In the case where the condition that no change occurs in the image data is kept for a predetermined period of time, the renewal is stopped and the mode is set up to be changed by the motion picture/still picture detecting circuit 13 structured so that the mode of the other area (area B) may be changed to the mode of renewing in real time when the change of the image data is detected from the condition that no change occurs continuously for the predetermined period of time. Namely, normally, the letter telop or the like that will run in moving on a next scene may be stored (frozen) automatically in the blank space. It is possible to constitute the advertisement image that not only may effectively utilize the large image field but also may propagate more effectively by the still image such as the letter telop in synergy with the motion picture.

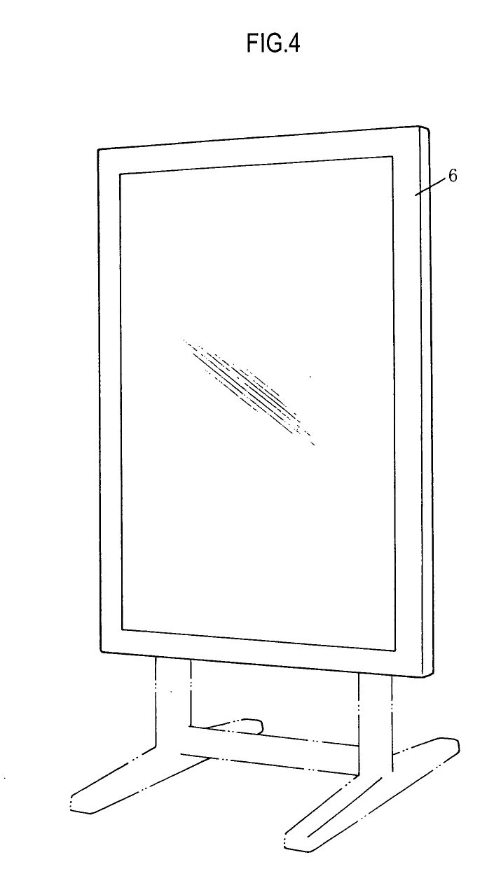

Incidentally, in the embodiment, the renewal area switching section 11 is automatically switched over in correspondence with a situation of the motion picture and the still picture of the image signal to be outputted from the image feeding unit 1. However, as shown in FIG. 3, a control signal for operating the above-described renewal area switching section 11 is included in the image signal to be outputted from the above-described image feeding unit 1 so that the mode of setting whether or not the turning image data of one area of the image memory and the other area are renewed automatically when the control signal is inputted may be set to be switched over. In this case, the scene that is considered as the most effective one by the person who produces the image may be displayed intentionally together with the motion picture to thereby enhance the advertisement effect more effectively. Also, it is possible to set the system so that the renewal area switching section 11 may be operated manually as desired. It is possible to set the system so that the switching operation is performed every predetermined period of time (for example, every ten seconds) by a timer.

Also, when the switching operation of the area to be renewed by the above-described renewal area switching section 11 is performed, in this embodiment, one area is once switched to the other area, that is, the switching is performed so that the image display area where the motion picture or the still picture is to be displayed is switched to the upper portion or the lower portion. It is possible to set the system so that the switching is performed plural times automatically when the switching is to be performed. For example, in the case where the switching is performed twice (even number of times) when the switching is to be performed, the image display areas of the vertical display 6 in which the motion picture or the still picture is displayed are not switched over and it is possible to always display the motion picture and the still picture, for example, in the upper portion and the lower portion, respectively. Also in case of audition near the vertical display, it is possible to constitute the advertisement image that may be subjected to the audition in a good condition. Furthermore, the switching is performed many times for a short period of times so that the image such as the motion picture may be displayed in the display areas on the upper and lower portions due to the residual image phenomenon.

Furthermore, the display apparatus according to the embodiment and a poster advertisement method using this display apparatus will now be described in more detail.

The display apparatus according to the embodiment is composed of an input section 2 connected to an output terminal of the image feeding unit 1 such as TV broadcasting, a VTR, a DVD, a camera or the like for inputting an image signal of jump scanning type to be outputted from this image feeding unit 1 in real time, a quantizing section 7 composed of a decoder circuit for quantizing the image signal of jump scanning type to be inputted from the input section 2 in real time, a scanning type converting section 3 composed of a sequential scanning circuit for converting the quantized image signal into the sequential scanning type image signal, a 90 degree image turning processing section 4 for turning the image by the image signal converted into the sequential scanning type in real time through 90 degrees (including 270 degrees), an image data outputting section 10 structured for always writing the turning image data already subjected to the 90 degree turning process, renewing this image memory in real time, and outputting the turning image data read out from this image memory so as to be fed and displayed in real time on this vertical display 6 and structured so that an area of the above-described image memory is divided into a plurality of areas and the turning image data written in each divided area may be displayed in the image display area corresponding to the above-described vertical display 6 divided in a plurality of areas in the same manner, a renewal area switching section 11 structured so that each area of the above-described memory may be changed from a mode of renewing the turning image data in real time to a mode of stopping the renewal or from the mode of stopping the renewal of the turning image data to the mode of renewing in real time, and an analogue signal portion 8 composed of a D/A converter for making the image signal, turned through 90 degrees, an analogue signals. The output section 5 is connected to an input terminal of the vertical display 6 set by changing the orientation of the laterally elongated signal receiver (laterally elongated display) through 90 degrees to thereby feed out and display the real time image that has been turned through 90 degree.

The image signal turned through 90 degrees and outputted in real time from such a display apparatus is fed and displayed in real time on the thin vertical plasma display set in a vertical direction by turning a wall hung thin horizontal color display (plasma display used in this case) so that the poster advertisement is achieved by the vertical plasma display where the image from the image feeding unit 1 is displayed in real time.

Incidentally, the jump scanning method means a method in which the transfer amount may be reduced to half. When a single image which is represented by 525 scanning lines is transferred by 60 frames per second, the transfer amount is increased. Accordingly, the one image is displayed by two frames. Namely, the odd number of the scanning lines from 1 to 525 is scanned for the first frame and the even number of the scanning lines from 2 to 524 is scanned for the next one frame. Accordingly, it appears that the motion picture of 60 frames per second is transferred to eyes due to a residual image phenomenon.

The sequential scanning method means a method in which the transfer amount is large but the flicker is negligible because the jump scanning is not conducted and all the 60 frames are transferred.

The sequential scanning circuit is adapted to convert the inputted jump scanning type image signal into the sequential scanning type.

Also, the 90 degree image turning processing section 4 is composed of a memory for quantizing and converting the inputted jump scanning type analog image signal into the sequential scanning type by the sequential scanning circuit and for storing as image data the jump scanning type image signal converted into the sequential scanning type and an address generating circuit for writing the image data into the memory write address that is the designated address of the memory and for reading out the image data from the memory readout address that is the designated address. When the image data are read out from the memory, the image data are turned through 90 degrees, and this turning image output may be displayed on the vertical display 6 through the D/A converter (analog signal section 8) in real time.

The address generating circuit is adapted to produce the memory write address in writing and the memory read out address where the 90 degree turning image is located in reading out.

Accordingly, in the embodiment, the area of the above-described image memory is divided in correspondence with the divided image display areas of the above-described vertical display. The normal image that may display the motion picture to be renewed in real time may be displayed in, for example, one area of the above-described vertical display by the display area switching section structured to make it possible to change to the mode of renewing in real time the turning image data written in each of these areas or the mode of stopping the renewal. One scene out of the images to be renewed in real time may be displayed in another predetermined area, i.e., a blank space. The blank space which is conventionally filled by using a plurality of image sources by a personal computer may be effectively utilized by a single image source without using any personal computer. It is therefore extremely easy to hand the system in a less expensive manner. The excellent advertisement effect due to the poster advertisement may be expected.

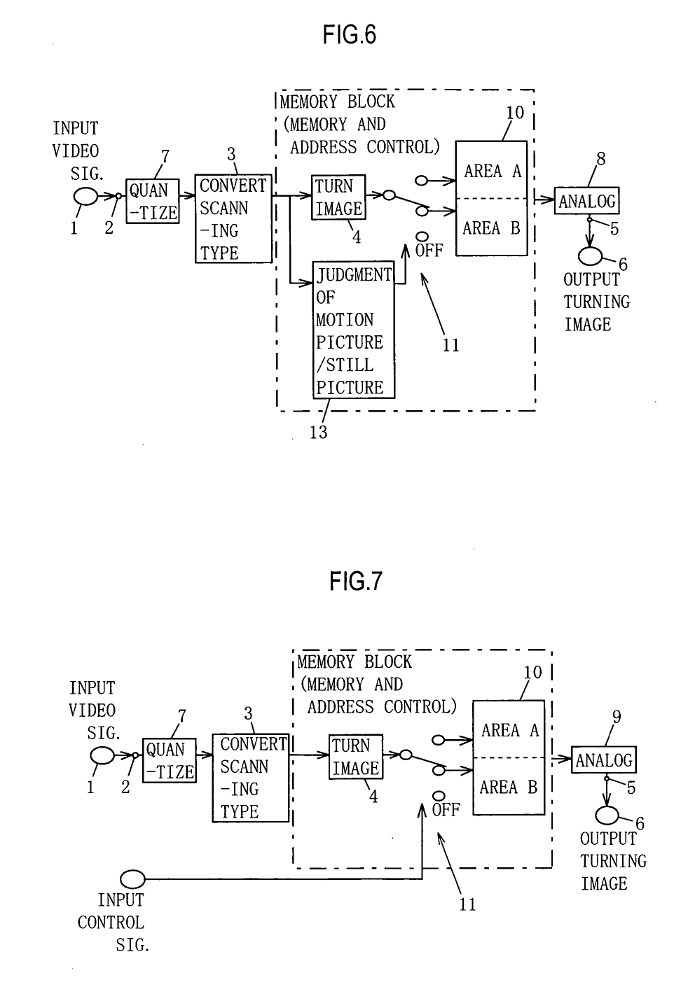

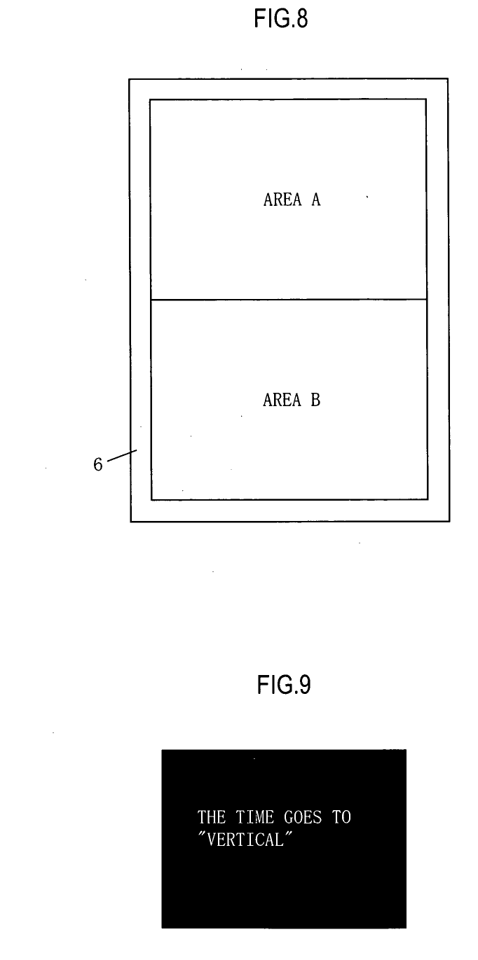

For example, one example will be described. In the case where TV commercial film to be inputted in real time and composed of a still image of a letter telop representing a company name or a product name and a motion picture for advertisement or introduction of the commercial product is displayed for the poster advertisement on a vertical display 6 which is a laterally elongated plasma display according to the display apparatus of this embodiment and which is set like a vertical signboard, for example, when, first of all, such contents that letters shown in FIG. 5 are fed to run, the motion picture is displayed in the upper image display area in real time during the run of the contents. When the run stops and the still picture condition is kept for a predetermined period of time (for example one second) or more, the renewal is stopped in the area (area A) of the image memory for feeding and displaying the image in the upper image display area of the vertical display 6 for displaying the still image. The still picture is displayed in this upper image display area (see FIG. 6).

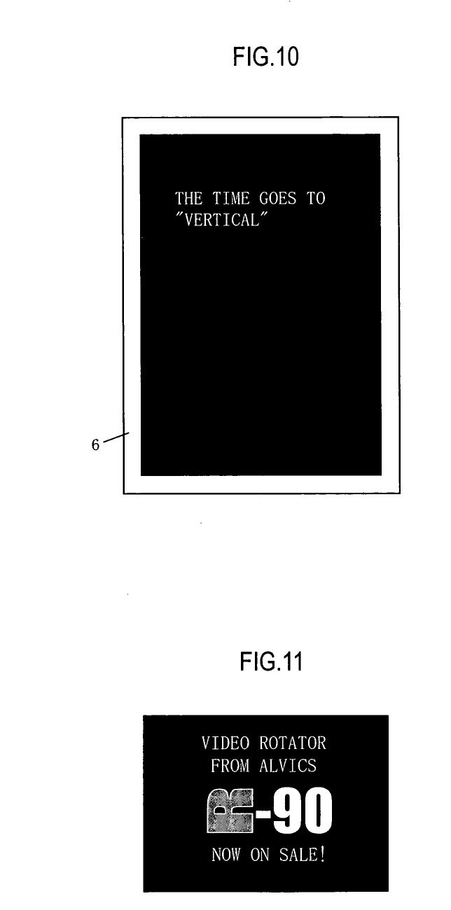

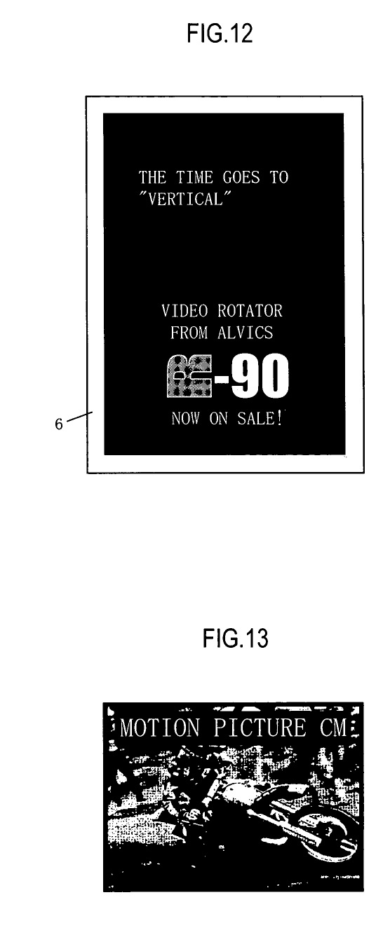

Subsequently, when the contents such that the image shown in FIG. 7 fades in are fed and the motion picture is detected, the above-described turned image data are renewed in real time in the area (area B) of the image memory for feeding and displaying the image in the lower image display area opposite to the area where the above-described still picture is displayed. The motion picture is displayed in this area B. When the motion stops and the condition of the still picture is going on as in the above-described case, the renewal stops in this area B. The still picture is displayed in the lower image display area (see FIG. 8).

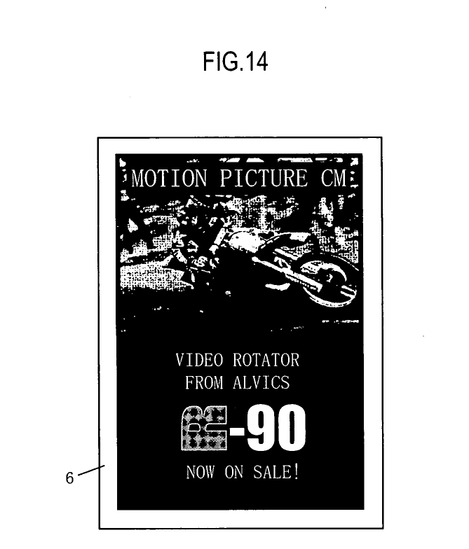

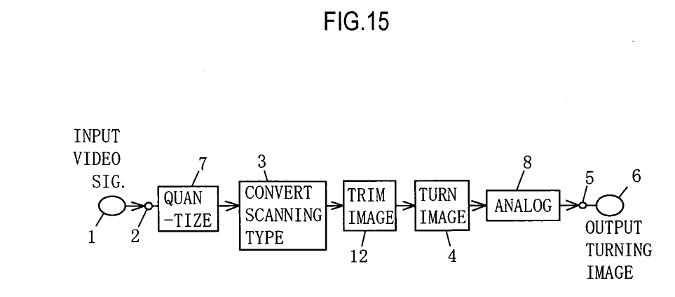

Furthermore, when the contents composed of motion pictures as shown in FIG. 9, the above-described turning image data are renewed in real time in the area A opposite to the area B where the motion picture is detected in the same manner and the above-described renewal stops. The motion picture is displayed in the upper image display area (see FIG. 10).

Namely, not only is it possible to display the TV image on air which could not be displayed conventionally on the vertical display 6 but also it is possible to display the motion image in the area opposite to the image display area where the still picture is displayed while storing (freezing) this still image on the upper portion or the lower portion of the vertical display 6, for example, whenever the still picture such as a letter telop is displayed. In the TV commercial film, the effect of the letter telop is further enhanced, and the extremely innovative and effective poster advertisement image that could not by attained by the conventional laterally elongated display may be displayed. It is possible to realize an innovative image signboard that may perform the excellent poster advertisement in an inexpensive manner and that is extremely easy to handle without needs of personal computers.

Incidentally, in this embodiment, the case where the NTSC image signal is outputted particularly from the image feeding unit 1 has been described in detail. The above-described image feeding unit 1 according to this embodiment is not limited to an image feeding unit that may output the image signal in real time such as TV broadcasting, a DVD, a VTR, a camera or the like. The unit may include concept of a unit that may once entrain the image signal of a personal computer and feed the image entrained. Accordingly, in this embodiment, not only the NTSC image signal but also the image distributed through an internet (broad band) may be displayed on the above-described vertical display 6 irrespective of wireless or wired systems.

Also, the system is set so that the scanning method is changed within the image feeding unit 1 whereby it is possible to display the image on the vertical display without needs of the above-described scanning type converting section 3 in the same manner as described above.

Also, in this embodiment, the case where the above-described image signal is turned through 90 degrees and displayed on the vertical display 6 which is set in particular by changing the orientation of the laterally elongated display into the vertical direction has been described in detail. However, it is possible to display the image on a laterally elongated display by turning the above-described image signal through 90 degree.

1.-28. (canceled)

29. A display apparatus characterized by comprising an input section for inputting an image signal outputted in real time from an image feeding unit such as a TV receiver, a VTR, a DVD, a camera or the like, a 90 degree image turning processing section for writing in a memory the image signal to be inputted in real time from the input section and making it possible for turning the written image data through 90 degrees and for feeding and displaying the data to the vertical display in real time, and an output section for outputting a sequential scanning type image signal turned through 90 degrees in real time, wherein the image of the image feeding unit turned through 90 degrees may be fed and displayed in real time on the vertical display which is set in the vertical direction by turning a laterally elongated display through 90 degrees, the turning image data already subjected to the 90 degree turning process by said 90 degree image turning processing section are always once written in an image memory, the image memory is renewed in real time, and the turning image data read out from the image memory is outputted to said vertical display so that the data may be fed and displayed in real time on the vertical display, further comprising an image data output section in which the turning image data written in each area which is obtained by dividing area of said image memory into a plurality of area may be displayed in a corresponding display area of said vertical display divided in a plurality of area in the same manner, and a renew area switching section structured to make it possible to change each area of said image memory from a mode of renewing the turning image data in real time to a mode of stopping the renewal of the turning image data or from the mode of stopping the renew of the turning image data to the mode of renewing the data in real time, wherein the image signal for advertisement turned through 90 degrees and outputted from said output section is inputted to said vertical display and the image of said image feeding unit may be displayed on said vertical display in real time and said renewal area switching section is set so as to switch a mode of whether or not the renewal of the turning image data is automatically performed in the divided area of the image memory in accordance with a signal contained in the image signal or a situation of a picture image or a still image of the image signal outputted from the image feeding unit.

30. The display apparatus according to claim 29, wherein turning image data to be renewed in real time in response to the image signal to be inputted in real time from the image feeding unit are displayed as a normal image that may represent a motion picture to the image display area of said vertical display corresponding to one area that is set to renew in real time the turning image data of said image memory, and the turning image data, renewed last, of the turning image data renewed in real time are displayed as a fixed image to said vertical display corresponding to other predetermined area that is set to stop the renewal of said turning image data whereby the fixed image and the normal image of the image signal from the image feeding unit may be displayed to said vertical display.

31. The display apparatus according to claim 29, wherein the overall image displayable range of the large size vertical display may be essentially occupied by a plurality of divided image display areas.

32. The display apparatus according to claim 31, wherein the overall image displayable range of the vertical display is divided into image display area juxtaposed in a vertical direction.

33. A display apparatus characterized by comprising an input section for inputting an image signal outputted in real time from an image feeding unit such as a TV receiver, a VTR, a DVD, a camera or the like, a scanning type converting section for converting into a sequential scanning type image signal a jump scanning type image signal inputted in real time from the input section or an image signal whose image has been turned through 90 degrees (including 270 degrees), a 90 degree image turning processing section for writing in a memory the image signal to be inputted in real time from the input section or the image signal converted into the sequential scanning type and for turning the written image data through 90 degrees and for feeding and displaying the data to the vertical display in real time, and an output section for outputting the sequential scanning type image signal turned through 90 degrees in real time, wherein the image of the image feeding unit turned through 90 degrees may be fed and displayed in real time on the vertical display which is set in the vertical direction by turning a laterally elongated display through 90 degrees, the turning image data already subjected to the 90 degree turning process by said 90 degree image turning processing section are always once written in an image memory, the image memory is renewed in real time, and the turning image data read out from the image memory is outputted to said vertical display so that the data may be fed and displayed in real time on the vertical display, further comprising an image data output section in which the turning image data written in each area which is obtained by dividing area of said image memory into a plurality of area may be displayed in a corresponding display area of said vertical display divided in a plurality of area in the same manner, and a renewal area switching section structured to make it possible to change each area of said image memory from a mode of renewing the turning image data in real time to a mode of stopping the renewal of the turning image data or from the mode of stopping the renewal of the turning image data to the mode of renewing the data in real time, wherein the image signal for advertisement turned through 90 degrees and outputted from said output section is inputted to said vertical display and the image of said image feeding unit may be displayed on said vertical display in real time and said renewal area switching section is set so as to switch a mode of whether or not the renewal of the turning image data is automatically performed in the divided area of the image memory in accordance with a signal contained in the image signal or a situation of a picture image or a still image of the image signal outputted from the image feeding unit.

34. The display apparatus according to claim 33, wherein turning image data to be renewed in real time in response to the image signal to be inputted in real time from the image feeding unit are displayed as a normal image that may represent a motion picture to the image display area of said vertical display corresponding to one area that is set to renew in real time the turning image data of said image memory, and the turning image data, renewed last, of the turning image data renewed in real time are displayed as affixed image to said vertical display corresponding to other predetermined area that is set to stop the renewal of said turning image data whereby the fixed image and the normal image of the image signal from the image feeding unit may be displayed to said vertical display.

35. The display apparatus according to claim 33, wherein the overall image displayable range of the large size vertical display may be essentially occupied by a plurality of divided image display areas.

36. The display apparatus according to claim 35, wherein the overall image displayable range of the vertical display is divided into image display area juxtaposed in a vertical direction.
